(19) United States
(12) Patent Application Publication
(10) Pub. No.: US 2008/0246733 A1
(43) Pub. Date: Oct. 9, 2008

(54) TV interface control system and method with automatic text entry

(76) Inventor: David L. Henty, Newport Beach, CA (US)

Correspondence Address: David L. Henty, Suite 1150, 19900 MacArthur Blvd., Irvine, CA, 92612, US

(21) Appl. No.: 12/080,535

(22) Filed: Apr. 3, 2008

Related U.S. Application Data
(60) Provisional application No. 60/921,717, filed on Apr. 4, 2007.
(60) Provisional application No. 60/927,762, filed on May 4, 2007.

(51) Int. Cl. G06F 3/02

(52) U.S. Cl. 345/168

(57) ABSTRACT

An automatic text entry system and method is disclosed which automatically displays a text entry menu on a TV in response to opening a remote control having an internal concealed keyboard. One of plural text entry modes may also be automatically selected based on past text entry mode selections or current viewing mode.

### RELATED APPLICATION INFORMATION

The present application claims priority under 35 USC 119(e) to provisional application Ser. No. 60/921,717 filed Apr. 4, 2007, and to provisional application Ser. No. 60/927,762 filed May 4, 2007, the disclosures of which are incorporated herein by reference in their entirety.

### BACKGROUND OF THE INVENTION

1. Field of the Invention

The present invention relates to TV interfaces and control systems and methods for controlling entertainment systems employing a TV as a display device.

2. Description of the Prior Art and Related Information

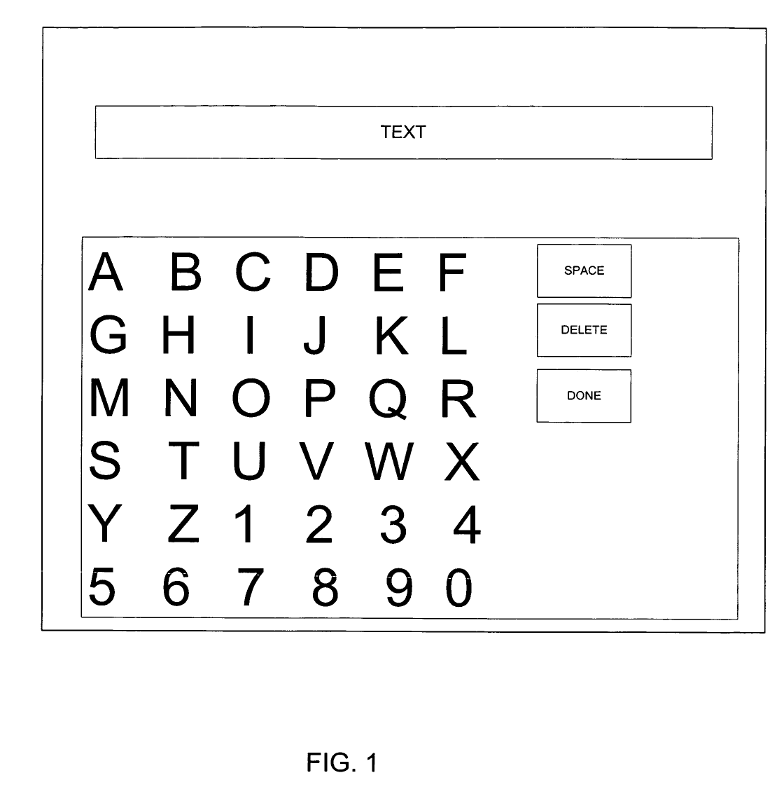

Modern TV based entertainment systems have the ability to access a large variety of content. Such content ranges from large numbers of digital TV channels, movies available through online pay per view or other subscription access services via cable or satellite, other online available media, as well as various locally stored media such as audio, pictures and video, and internet access. Accessing such content efficiently is impossible without employing a search feature of some type. At the same time control of a TV based system is typically via a handheld remote control. The majority of remote controls employ an Up-Down-Left-Right (UDLR) set of control buttons to navigate through the various menus to control the entertainment system. Employing this type of menu control for searching typically involves going through a series of menu prompts with the UDLR control buttons to initiate a search followed by text entry for the search again using the UDLR buttons. This text entry involves an on screen alpha numeric listing which is scrolled through via the UDLR control buttons to select text and numbers one letter or number at a time. A typical search menu layout of this type is shown in FIG. 1.

Also, a number of other features accessible on the TV in modern digital media systems involve text input. If the TV connected device is connected to the internet these text entry features may include email or instant messaging. Also, various TV interactive features involving text input are being implemented, such as interactive commenting, rating or voting on programs, accessing information on programs via text questions, real time chatting with other viewers, etc.

On screen alpha numeric listings for text entry from remote controls generally fall into two types, one a keyboard style listing of the alphabet and numbers such as shown in FIG. 1 and the other a keypad type layout similar to a telephone keypad which uses a texting type input format. In either case the input of text is extremely slow requiring repeated activation of the UDLR control buttons. This limitation on text entry from a remote control has limited the desirability of text entry functions including search, email, and various interactive features and hampered user acceptance and use of digital media systems and the large variety of text related functions which are potentially available.

Accordingly a need exists for an easier way to enter text using a handheld remote control.

### SUMMARY OF INVENTION

In a first aspect the present invention provides a method for automatically entering a text entry mode in a TV environment comprising detecting opening of a remote control having a concealed text entry keyboard and displaying a text entry menu on the TV screen having plural text entry options in response to the detecting.

In a preferred embodiment of the method the plural text entry options may include an interactive text entry mode and a search mode. For example, the interactive text entry mode may comprise one of chat, email or instant messaging. As another example the interactive text entry mode may comprise text entry for interactive shopping. The remote control may comprise a folding remote with a QWERTY keyboard on the inner surfaces of the folding remote and the detecting comprises detecting opening of the folding keyboard. The method may further comprise detecting closing of the remote and returning to the prior viewing mode if a text entry mode is not selected.

In another aspect the present invention provides a method for initiating a text entry based mode in a TV environment, comprising detecting activation of a text entry keyboard in a remote control, selecting one text entry mode from a plurality of text entry modes based on the current display mode on the TV when the detecting occurs, and displaying a text entry menu on the TV screen corresponding to the selected text entry mode.

In a preferred embodiment the method may further comprise toggling through different text entry modes in response to activation of a text mode key in the text entry keyboard. The display modes may include display of interactive program viewing and display of non-interactive program viewing and the selecting may comprise selecting an interactive text entry menu when the current display mode on the TV when detecting occurs is display of interactive program viewing. For example, the interactive program viewing may comprise chat, email or instant messaging enabled programming and the interactive text entry menu may comprise one of chat, email or instant messaging. The text entry menu may be displayed in a partial screen along with the program being viewed. A search menu may be selected when the current display mode on the TV when detecting occurs is display of non-interactive program viewing. The selecting of a text entry mode may be based on a channel by channel basis in determining if the programming is interactive. The selecting may also be based on a program by program basis in determining if the programming is interactive.

In another aspect the present invention provides a method for automatically initiating a text entry mode in a TV environment, comprising detecting activation of a text entry keyboard in a remote control, selecting one of a plurality of different text entry menus based on one or more prior text entry modes of the user, displaying the selected text entry menu on the TV screen in response to the detecting, and entering text into the menu in response to text entry from the keyboard.

In a preferred embodiment of the method a prior text entry mode of the user may comprise email and the selected text entry menu may comprise an email menu. As another example, a prior text entry mode of the user may comprise interactive shopping and the selected text entry menu may comprise an interactive shopping menu. The prior text entry modes of the user may comprise plural different prior text entry modes and selecting a text entry menu may be based on a pattern of selecting text entry modes by the user.

In another aspect the present invention provides an entertainment system adapted for use with a TV, comprising a media device adapted to be coupled to the TV and control display of media including TV shows, and a remote control having an open and closed configuration with first inputs accessible in the closed configuration and second inputs including text entry keys accessible in the open configuration, the remote including one or more transmitters for transmitting controls signals to the media device including a signal indicating opening of the remote. The media device includes control programming to initiate display of a text entry menu automatically in response to receiving the control signal indicating opening of the remote and to receive text entry transmitted from the remote from activation of the text entry keys.

In a preferred embodiment of the entertainment system the media device is adapted to display interactive and non-interactive content and the control programming selects the text entry menu based on the type of content displayed.

Further aspects of the invention will be appreciated from the following detailed description of the invention.

### BRIEF DESCRIPTION OF THE DRAWINGS

In FIG. 1 a text entry screen with an on screen keyboard layout is shown.

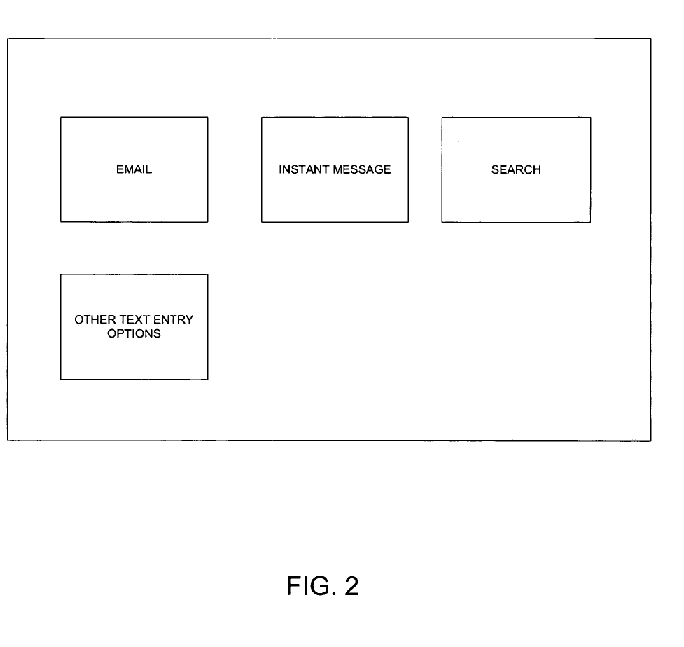

In FIG. 2 a text entry menu in accordance with the invention is illustrated.

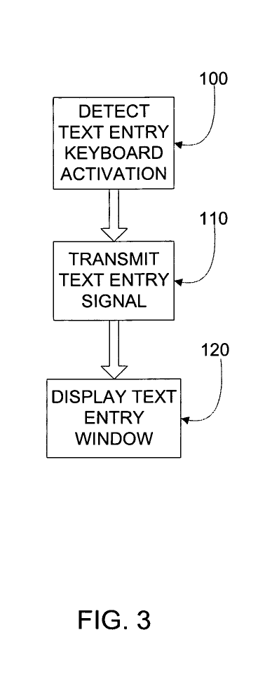

In FIG. 3 an interface control method accordance with the invention is illustrated.

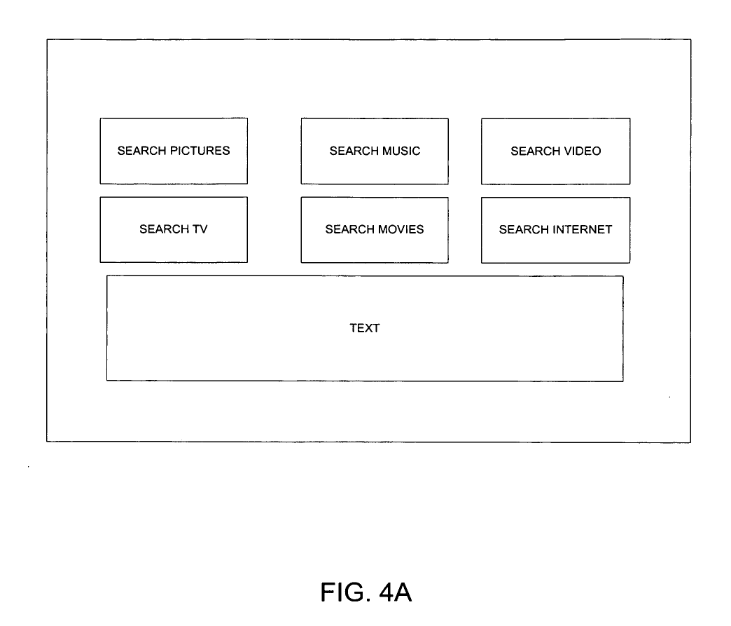

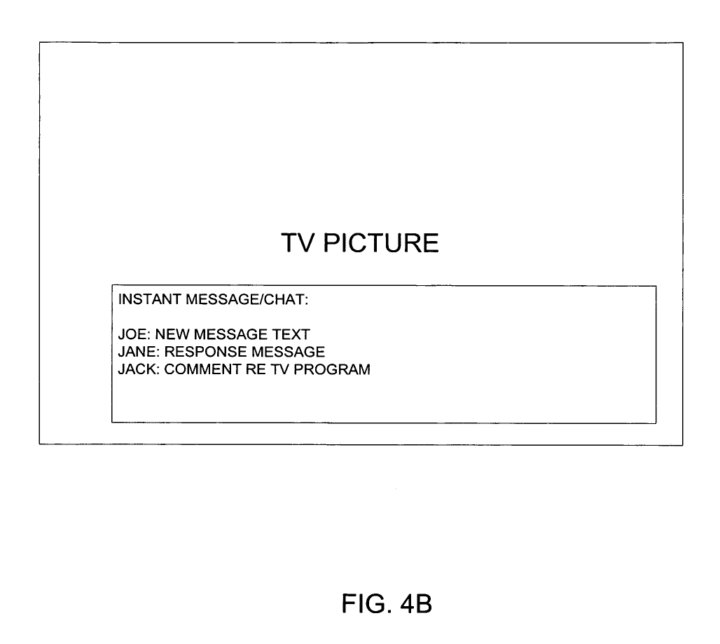

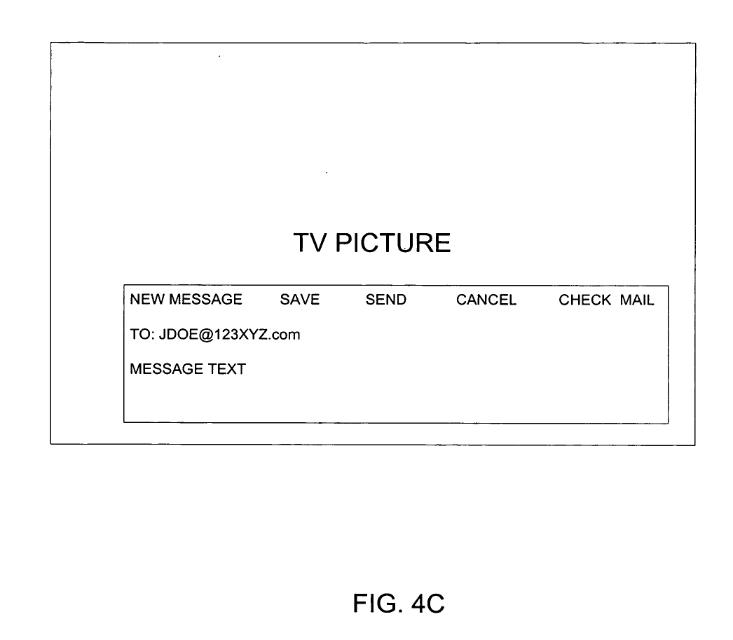

In FIGS. 4A-4C text entry menus are illustrated for an embodiment of the invention where several different text entry modes are available.

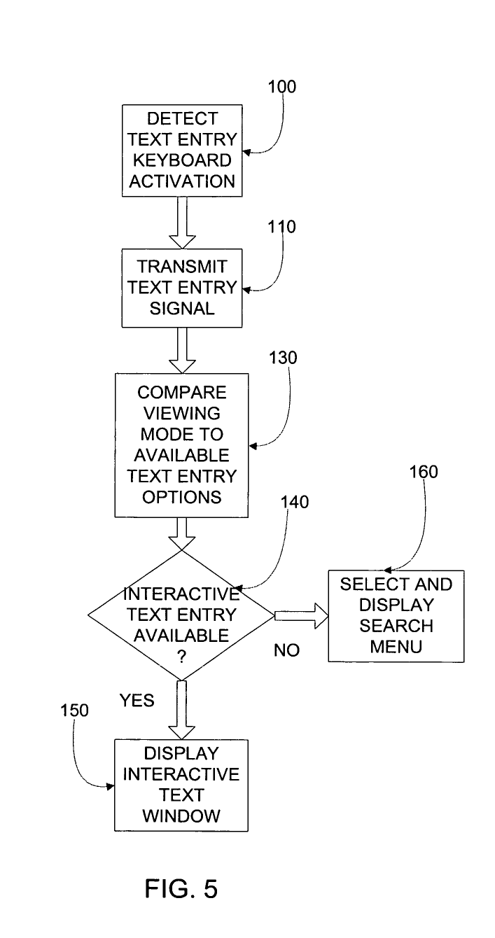

In FIG. 5 the interface control flow is illustrated in accordance with an embodiment of the invention where different search text entry modes are available.

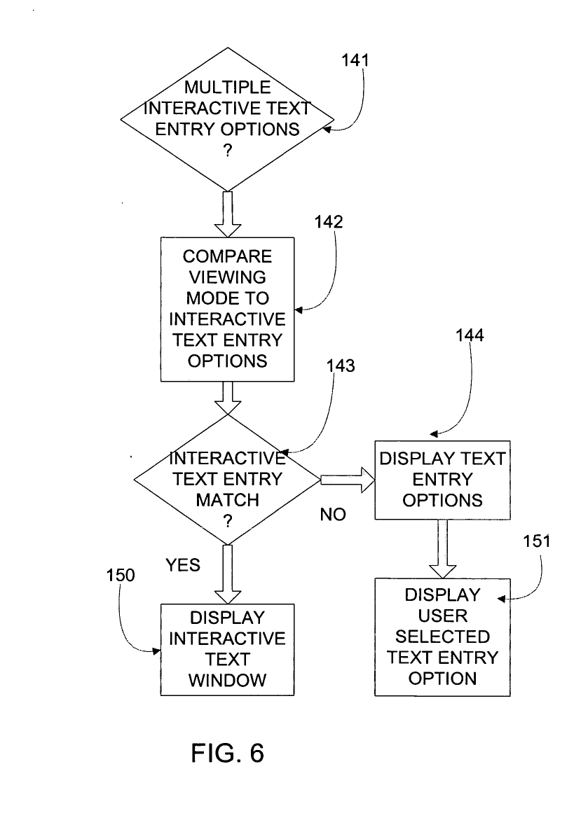

In FIG. 6 the interface control flow is illustrated in accordance with an alternative embodiment of the invention.

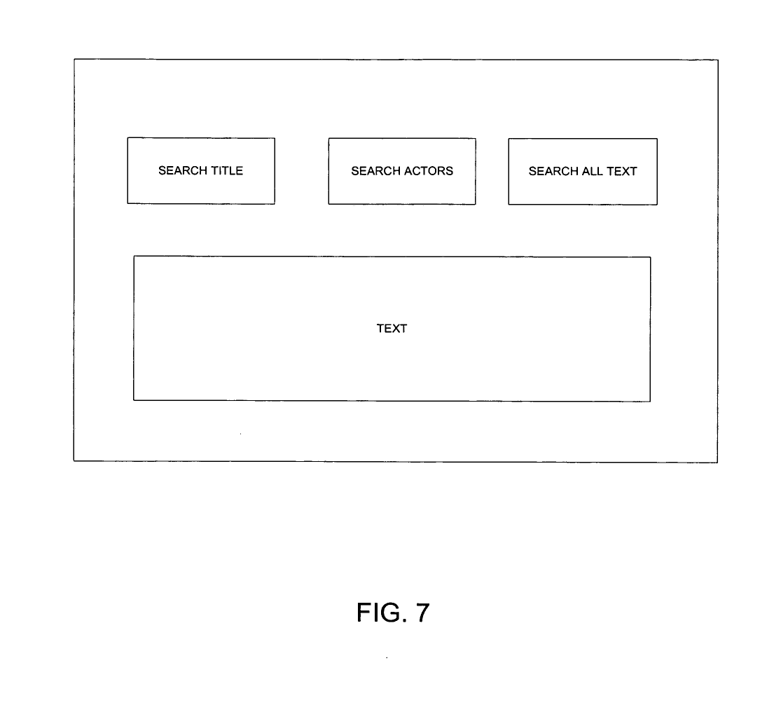

In FIG. 7 a search menu in accordance with the invention is illustrated.

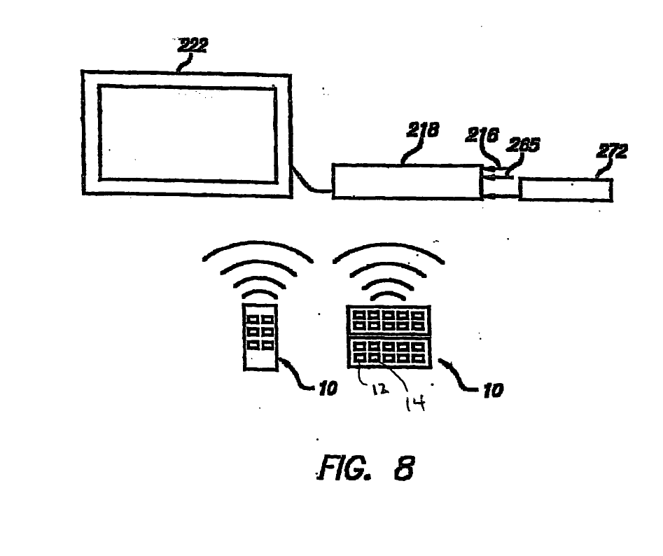

In FIG. 8 an improved entertainment system employing the automatic text entry features in accordance with the present invention is illustrated.

### DETAILED DESCRIPTION OF THE INVENTION

U.S. Pat. No. 6,094,156 ('156 patent) and U.S. Pat. No. 7,123,242 ('242 patent) are incorporated herein by reference in their entirety. In the above noted '156 and '242 patents the above noted problems were addressed by a folding remote control system and method with a keyboard configured on the inner surfaces of the folding remote. This system and method allows easy text entry when desired by opening the folding remote and using the keyboard within the remote. The remote also has conventional UDLR buttons on the outside of the remote allowing control of menus in a conventional manner. The present invention provides a TV interface and control method adapted for simple and quick text entry which may preferably employ such a remote with keyboard.

Referring to FIG. 2 an example of a text entry window for interactive TV applications is illustrated. In this example the text entry options include email, instant messaging or chat, search, as well as various other possible options illustrated generically but without limitation. In a typical interface control the various text entry options shown in FIG. 2 would be independently accessed through a variety of steps from a main menu all controlled via UDLR buttons using highlighting of options and selection. In accordance with the present invention however a text entry window such as in FIG. 2 is automatically generated. This window may include a text entry box for immediate text entry into a highlighted box or text entry may be provided when the text entry option is selected from the menu. Selection of the text entry box within FIG. 2 may be via UDLR arrows and using select/OK on the open keyboard keys or via a dedicated text mode select button 12 as indicated generally in FIG. 8.

More specifically, referring to FIG. 3 the interface control method in a first embodiment is illustrated. During operation with the remote closed and using UDLR controls the conventional menu navigation may be employed. When the remote is opened to expose the internal text entry keyboard this is detected at 100. More specifically, as described in the above noted patents the remote has a sensor which detects opening of the remote which is used to disable the outside buttons. For example as described in the noted patents the switch may be coupled to a latch or to a hinge. At 110 this remote opening detection is used to transmit a signal using the remote control transmitter (either IR or RF) to the entertainment control device 218 or TV 222 (FIG. 8) to control the displayed interface. At 120 in response to this signal the device 218, 222 automatically displays a text entry window such as in FIG. 2. The illustrated text entry modes are not limiting and various other may be provided such as interactive shopping, interactive information display, such as weather, etc., interactive multi-player gaming, etc. The text entry window may be superimposed on the menu or program being viewed when the signal is received in a partial screen window which menu may be easily accommodated in a partial screen due to the lack of need for the text of the menu of FIG. 1. Alternatively the text entry window may be displayed full screen displacing the menu or program being viewed on the screen of TV 222. In either case the user is able to immediately enter text for the interactive text application. It will readily be appreciated that this automatic text entry control is dramatically simpler and faster than conventional approaches using a remote.

Referring to FIGS. 4-6 text entry menus and interface control flow are illustrated for an application where several different text entry options are available which may vary on a channel by channel basis. For example, the media control device 218 may access a large number of TV channels some of which are enabled for interactive applications such as instant messaging or chat and some of which are not. Also the device or TV may access locally stored (including locally networked storage) pictures, music and video files in a typical digital multi-media entertainment system, as well as TV channels/programs and on demand movie content as described above. Also email capability may be available. Also, depending on the device 218 internet search capability may also be provided.

As a specific example, referring to FIGS. 4A-4C examples of text entry windows for interactive TV applications are illustrated. FIG. 4A is a search menu adapted for use with keyboard text entry rather than UDLR entry. This menu illustrates a general search menu adapted for example for selection of one of several search options. If toggling through search modes is done with a dedicated search mode button 14 on the keyboard the icons for this search mode selection may be dispensed with making more on screen room. Also since an on screen keyboard is not needed (as in FIG. 1) considerable space is available. This extra room may be used for PIP display of the program or content viewed before the search screen mode is entered or for display of links, ads etc. As examples, links may be to separate channels or VOD programming. The displayed ads or links may be context sensitive being displayed based on nature of the search. FIG. 4B illustrates a text entry window for an instant message or chat enabled TV program or other similar text interactive application. In the case of such a chat/instant message interactive application the interactive mode may be time correlated with a specific program (and not all programs on a given channel may be chat enabled). FIG. 4C in turn illustrates an email window. As shown these windows may be superimposed on a TV program or other video display on the TV. Various other text entry options other than FIGS. 4A-4C are possible with associated menus. Examples include interactive multi-player gaming with text entry for game selection and communication with other players, interactive shopping, and interactive information access, such as requests for weather in specific cities, etc. Also a telephone access capability may be provided and text message review and creation may be provided as a text entry option. Such telephone access using a remote is described in the above noted '242 patent incorporated herein by reference.

In FIGS. 5-6 the control flow is illustrated in an embodiment where automatic selection of a specific text entry menu is provided, for example between one of the menus of FIGS. 4A-4C, in response to an automatically generated text entry signal. As in the example of FIG. 3 above the control flow proceeds at 100 and 110 to detect keyboard text entry and transmit a signal to automatically initiate text entry menu display. Since multiple text entry options are available the flow proceeds at 130 to compare the viewing mode to text entry options. This comparison will be a function of the specific TV/video program or media source being displayed, on a channel by channel basis (and potentially on a program by program basis). As discussed above, some TV channels may support interactive text based interaction and other channels may not. Similarly in a gaming application, some games or gaming sites may support interactive multi-player gaming or other text based interaction and some may not. Therefore, at 140 it is determined if the mode available from the displayed content supports interactive functionality, e.g., is the displayed channel a chat enabled interactive channel. At 150 the selected interactive text entry menu, such as FIG. 4B-4C, is displayed. This step may include a code conversion from the (IR code or RF code) 110 indicating text entry to the code for the text interactive display mode selected for the specific channel and program. This code conversion may involve several codes sent to the interactive interface (e.g., via an OCAP protocol) to go directly to the interface 4A-C. For example, the channel may have a concealed mode with chat/instant messaging involving several menu selections to enter a displayed chat/instant messaging window. This code conversion mapping may be stored on the device 218, 222 and will in general vary on a channel by channel basis (and program by program basis). At 150 this series of code transmissions and/or selections cause automatically display of the text entry window which is then responsive to text entry from the keyboard. The displayed menu may include a change entry selection which takes the displayed menu to a higher level as in FIG. 2 to allow user selection of the text entry menu if the automatically displayed menu is not the one desired. Alternatively, the change search selection may scroll through successive search fields/media groups using an on screen text entry selection change icon. Also, instead of the manual change search selection being on screen, a dedicated text mode button 12 may be provided on the keyboard to scroll (or toggle) through text entry modes and/or search modes to further speed text entry selection and reduce on screen menu navigation (FIG. 8). This also allows more on screen room since text entry options are not displayed on screen. If at 140 it is determined no interactive text mode is available, the default text entry may go to search mode at 160. The search menu may be a high level menu as in FIG. 4A or a selective processing may be employed to select a specific search menu, such as illustrated in FIG. 7 for example, as described in the provisional patent application entitled TV Interface Control System and Method With Automatic Search, Ser. No. 60/919,683 filed Mar. 23, 2007, by the present applicant the disclosure of which is incorporated herein by reference. If toggling through search categories is done with a dedicated search mode button the icons for this selection may be dispensed with making more on screen room for links, ads etc.

These automatic menu selection steps 130, 140, 150 (coupled with the manual text entry change selection) may incorporate a memory and learning function. For example, an automatic text menu selected at 130-150 from live TV program viewing from a chat/instant message enabled channel may typically go to a TV text entry window as in FIG. 4B. However, if this automatic selection is repeatedly altered via a manual change to an email text menu as in FIG. 4C, then an email window as in 4C will become the default automatic text entry window displayed at 150. This learning feature may be user settable as to the number of changes required before altering the default automatic menu selection and also may be reset to the original default by the user.

Referring to FIG. 6, a control process flow is illustrated where multiple interactive text entry selections are available. Therefore, a more complicated process flow corresponding to 140 and 150 described above may be provided as shown by 141-151. In particular, at 142 the mode being viewed is compared to plural interactive text entry options, such as chat, comment, vote, retrieve detailed program information (such as actor details, past episode information), etc. This comparison 142 is context sensitive and may preferably employ the past selection decisions in determining a match. If at 143 a specific text entry selection is confirmed the text entry window is displayed at 150. If not the higher level text option window such as in FIG. 2 is displayed at 144 and the user selects the text entry option which is displayed at 151.

Referring to FIG. 8 an improved entertainment system employing the automatic text entry features in accordance with the present invention is illustrated. As shown, the entertainment system includes a TV monitor 222 which is coupled to a data processing device 218 of the type which receives text input control signals for text input as described above and controls the interface displayed on the TV. Also, additional devices or inputs may be provided to the entertainment system, e.g., a DVR 272, wired or wireless networked device coupled to a PC or other media server and other video and data inputs indicated generally by inputs 216 and 265 in FIG. 8. Also shown is remote 10, illustrated in both the first (open) and second (closed) configurations as described above. Remote 10 provides typical TV type control signals to the entertainment system in the second (closed) position, such as volume up/down and power, and text input control signals in the first (open) position as described above, and detects opening and transmits the text input activation signal as described at 100, 110 above. Also in the open position the keys may preferably include a text mode key 12 for toggling through text entry modes, a search mode key 14 for toggling through search menus for different media groups and/or a search mode key for toggling through search fields or categories as described above. In the case of multi-player gaming applications the remote may be configured as a game controller with concealed keyboard or the remote in open configuration may be used for gaming with the keyboard used for gaming control and may have dedicated gaming keys or inputs. Other features of an interactive entertainment system with interactive modes using text entry may be provided, for example as described in U.S. Pat. No. 5,675,390, the disclosure of which is incorporated herein by reference in its entirety.

Although the above automatic text entry features preferably employ a device 218 such as a set top box, networked PC or other media control device adapted for the search and text entry described, in some cases the use of older devices or devices without dedicated process flow as above may be used by transmitting commands, such as macros of plural rapid commands to emulate the desired functions on an existing device. For example, a macro of commands may be transmitted upon detecting opening of the remote which takes the display to a search menu normally accessed via a series of menu selections. Also a device adapted for text entry via an on screen or triple tap type input may be used to generate text from the remote QWERTY keyboard by emulating the text entry commands with a series of commands triggered by activation of each key on the keyboard.

Although the interface control described above is preferably employed with the folding remote illustrated in FIG. 8 and described in the above patents incorporated by reference and responsive to opening the remote, the keyboard text entry detection at 100 above and ensuing control flow may also be initiated by another means such as detection of a text key being pressed in the keyboard or activation of a text or search button on the keyboard. In such alternate embodiments the keyboard may be configured differently than the preferred folding design or may even be separate from the remote.

It will be appreciated by those skilled in the art that the foregoing is merely an illustration of the present invention in currently preferred implementations. A wide variety modifications to the illustrated embodiments are possible while remaining within the scope of the present convention. Therefore, the above description should not be viewed as limiting but merely exemplary in nature.

What is claimed is:

1. A method for automatically entering a text entry mode in a TV environment, comprising:
detecting opening of a remote control having a concealed text entry keyboard; and
displaying a text entry menu on the TV screen having plural text entry options in response to said detecting.

2. A method for automatically entering a text entry mode in a TV environment as set out in claim 1, wherein said plural text entry options include an interactive text entry mode and a search mode.

3. A method for automatically entering a text entry mode in a TV environment as set out in claim 2, wherein said interactive text entry mode comprises one of chat, email or instant messaging.

4. A method for automatically entering a text entry mode in a TV environment as set out in claim 2, wherein said interactive text entry mode comprises text entry for interactive shopping.

5. A method for automatically entering a text entry mode in a TV environment as set out in claim 1, wherein said remote control comprises a folding remote with a QWERTY keyboard on the inner surfaces of the folding remote and wherein said detecting comprises detecting opening of the folding keyboard.

6. A method for automatically entering a text entry mode in a TV environment as set out in claim 1, further comprising detecting closing of the remote and returning to the prior viewing mode if a text entry mode is not selected.

7. A method for initiating a text entry based mode in a TV environment, comprising:
detecting activation of a text entry keyboard in a remote control;
selecting one text entry mode from a plurality of text entry modes based on the current display mode on the TV when said detecting occurs; and
displaying a text entry menu on the TV screen corresponding to said selected text entry mode.

8. A method for initiating a text entry based mode in a TV environment as set out in claim 7, further comprising toggling through different text entry modes in response to activation of a text mode key in said text entry keyboard.

9. A method for initiating a text entry based mode in a TV environment as set out in claim 7, wherein said display modes include display of interactive program viewing and display of non-interactive program viewing and wherein said selecting comprises selecting an interactive text entry menu when said current display mode on the TV when said detecting occurs is display of interactive program viewing.

10. A method for initiating a text entry based mode in a TV environment as set out in claim 9, wherein said interactive program viewing comprises chat, email or instant messaging enabled programming and said interactive text entry menu comprises one of chat, email or instant messaging.

11. A method for initiating a text entry based mode in a TV environment as set out in claim 9, wherein said text entry menu is displayed in a partial screen along with the program being viewed.

12. A method for initiating a text entry based mode in a TV environment as set out in claim 9, wherein said selecting comprises selecting a search menu when said current display mode on the TV when said detecting occurs is display of non-interactive program viewing.

13. A method for initiating a text entry based mode in a TV environment as set out in claim 9, wherein said selecting is based on a channel by channel basis in determining if the programming is interactive.

14. A method for initiating a text entry based mode in a TV environment as set out in claim 9, wherein said selecting is based on a program by program basis in determining if the programming is interactive.

15. A method for automatically initiating a text entry mode in a TV environment, comprising:
detecting activation of a text entry keyboard in a remote control;
selecting one of a plurality of different text entry menus based on one or more prior text entry modes of the user;
displaying the selected text entry menu on the TV screen in response to said detecting; and
entering text into the menu in response to text entry from the keyboard.

16. A method for automatically initiating a text entry mode in a TV environment as set out in claim 15, wherein said prior text entry modes of the user comprises email and wherein the selected text entry menu comprises an email menu.

17. A method for automatically initiating a text entry mode in a TV environment as set out in claim 15, wherein said prior text entry modes of the user comprises interactive shopping and wherein the selected text entry menu comprises an interactive shopping menu.

18. A method for automatically initiating a text entry mode in a TV environment as set out in claim 15, wherein said prior text entry modes of the user comprise plural different prior text entry modes and said selecting is based on a pattern of selecting text entry modes by the user.

19. An entertainment system adapted for use with a TV, comprising:
a media device adapted to be coupled to the TV and control display of media including TV shows; and
a remote control having an open and closed configuration with first inputs accessible in the closed configuration and second inputs including text entry keys accessible in the open configuration, the remote including one or more transmitters for transmitting controls signals to said media device including a signal indicating opening of the remote;
the media device including control programming to initiate display of a text entry menu automatically in response to receiving said control signal indicating opening of said remote and to receive text entry transmitted from said remote from activation of said text entry keys.

20. An entertainment system adapted for use with a TV as set out in claim 19, wherein the media device is adapted to display interactive and non-interactive content and wherein control programming selects said text entry menu based on the type of content displayed.
